(19) United States
(12) Patent Application Publication
(10) Pub. No.: US 2014/0007564 A1
(43) Pub. Date: Jan. 9, 2014

(54) POWER GENERATION BY PRESSURE RETARDED OSMOSIS IN CLOSED CIRCUIT WITHOUT NEED OF ENERGY RECOVERY

(71) Applicant: Avi Efraty, Har Adar (IL)

(72) Inventor: Avi Efraty, Har Adar (IL)

(21) Appl. No.: 14/007,025

(22) PCT Filed: Apr. 15, 2012
(86) PCT No.: PCT/IL12/50135

§ 371 Date: Sep. 24, 2013

(30) Foreign Application Priority Data
Apr. 12, 2011 (IL) 212272

(51) Int. Cl. F15B 15/18

(52) U.S. Cl. CPC F15B 15/18
USPC 60/327; 60/328

(57) ABSTRACT

A method and apparatus for clean energy generation by means of Pressure Retarded Osmosis (PRO) in closed circuit by a batch process or by a consecutive sequential process comprises two sections; one of a disengaged Side Conduit (SC) undergoing replacement of High Salinity Diluted Concentrates (HSDC) by fresh High Salinity Feed (HSF); and the other of a close circuit system with 3 modules connected in parallel wherein Low salinity feed (LSF) is continuously supplied and whereas part of the HSDC is being recycled through said modules and the other part used for power generation by means of a fixed speed turbine (T) and 3 rated generators (G1, G2 and G3) which are actuated simultaneously or separately as function the power availability during the PRO process. Periodic engagement of said SC with HSF and the closed circuit enable replacement of pressurized HSDC by fresh HSF without stopping the power generation process.

### BACKGROUND OF THE INVENTION

### Field of Invention

The invention pertains to the field of power generation by means of pressure retarded osmosis driven by forward osmosis flow across semi-permeable membranes from one feed solution of low salinity to another feed solution of higher salinity with osmotic pressure difference manifesting the pressure in the system. The invention describes apparatus and methods for power generation by means of pressure retarded osmosis in closed circuit with high efficiency and without need energy recovery.

Forward Osmosis (hereinafter “FO”) is a spontaneous natural phenomena involving transport of water across semi-permeable membranes from a less concentrated to a more concentrated solution; whereas, Reverse Osmosis (hereinafter “RO”) is the opposite process encountered when a sufficiently high external pressure applies to the more concentrated solution. The flux of permeation across semi-permeable membranes in FO depends on the osmotic pressure difference (hereinafter “Δπ”) between the high salinity and low salinity feed solutions; whereas, in case of RO the flux depends on the Net Driving Pressure or applied pressure less Air.

While commercial processes on the basis of RO dominate today the desalination markets worldwide, applications of FO for clean power generation are legging behind due to the complexity of making such pressure retarded osmosis processes (hereinafter “PRO”) energy efficient and economically viable. The pioneering contribution to the field of FO power generation was made by Loeb and described in the U.S. Pat. Nos. 3,906,250 and 4,193,267 under the terminology of “pressure retarded osmosis”. Since, relatively few meaningful contributions were made in this field, among which noteworthy are the contributions by Jellinek in the U.S. Pat. No. 3,978,344 of a Seawater/Freshwater system; Lmapi et al. in the U.S. Pat. No. 7,303,674 of a system for generating a significant hydraulic pressure which may apply to RO; Alstot et al. in the U.S. Pat. No. 7,329,962 of a hydrocratic generator driven by high/low salinity fluids; Robert Mc Ginnis et al. in the international application PCT/US2007/023541 of a closed cycle PRO process also comprising ammonia-carbon dioxide draw solution; and by Maher I. Kaleda in the patent application US 2011/0044824 A1 of “Induced Symbiotic Osmosis for Salinity Power Generation”. A related contribution of a pseudo-osmosis process for energy generation from different salinity sources without semi-permeable membranes were described by Finley et al. in the U.S. Pat. Nos. 6,313,545 and 6,559,554.

The first and only operational PRO power plant was commissioned several years ago in Norway by the Statkraft company and this plant operates on the basis of the technology by Thor Thorsen and Torleif Holt in patent No 31475 B1. This plant utilizes Ocean Water and fresh river water across semi-permeable membranes and operates in the PRO range of 11-15 bar, with 1/3 of the pressurize effluent diverted to a turbine for electric power generation and 2/3 of the pressurized effluent diverted to a pressure exchanger in order to pressurize the Sea Water feed supply with minimum loss of energy.

### SUMMARY OF THE INVENTION

The presence invention describes apparatus and methods for rated electric power generation by PRO in close circuit (hereinafter “CC”) from a Low Salinity Feed (hereinafter “LSF”) in the presence of a recycled High Salinity Feed (hereinafter “HSF”) across semi-permeable membranes in pressure vessels (hereinafter “MOD” irrespective of number of vessels), wherein, permeation by FO from inside out of said membranes creates a flow of pressurized High Salinity Diluted Concentrates (hereinafter “HSDC”) for power generation applications. The inventive PRO apparatus also comprises means for CC recycling of HSDC from outlet(s) to inlet(s) of MOD and a line extension from said CC to a turbine (hereinafter “T”), or hydraulic motor (hereinafter “M”) instead, with a Variable Flow Valve (hereinafter “VFV”) and Flow Meter (hereinafter “FM”) means to enable fixed flow and constant speed actuation of T, or M instead, for rated electric power production by means of one or of several rated electric generators (hereinafter “G”) of alternating and/or simultaneous actuation modes through the shaft (hereinafter “S”) of said T, or M instead, as function the pressure manifested torque availability on said shaft of T, or M instead, during the PRO process.

Continuous PRO electric power generation in CC proceeds according to the inventive apparatus and method by means of periodic engagement of a single Side Conduit (hereinafter “SC”) with said CC to enable HSF supply to inlet(s) of MOD with simultaneous removal of HSDF from outlet(s). After the entire HSDF volume in said MOD replaced with fresh HSF by said engagement, the SC is disengaged from MOD, decompressed, recharged by replacement of HSDF with HSF, compressed, and left on stand-by for the next engagement with MOD. During said disengaged mode of SC, feed to MOD comprises of recycled HSDF in CC.

The making of PRO electric power generation in CC continue with none stop supply of HSF to inlet(s) of MOD with simultaneous removal of HSDF from outlet(s) according inventive apparatus and method is made possible by the alternating engagement of two SC with said MOD, such that while one SC is pressurized and engaged with MOD, the other SC is disengaged, decompressed and undergoing replacement of HSDF with HSF in readiness for the next engagement. The continuous supply of HSF to inlet(s) of MOD in said apparatus with two alternately engaged SC imply a single power production, therefore, the continuous application of just one rated electric generator.

Other components of the inventive apparatus comprise a low pressure pump (hereinafter “P_{LSP}”) with line and valve means for LSF supply to inlet(s) of MOD and Low Salinity Concentrate (hereinafter “LSC”) discharge from outlet(s); a low pressure pump (hereinafter “P_{HSF}”) with line and valve means for replacement of HSDF with HSF in a disengaged decompressed SC, and various monitoring means of pressure (hereinafter “PM”), conductivity (hereinafter “CM”), and flow (hereinafter “FM”) to enable the control of said apparatus and the follow up of their performance.

### BRIEF DESCRIPTION OF THE DRAWINGS

FIG. 1: Illustrates a schematic drawing of a single MOD module batch apparatus for PRO in CC with a single electric generator for rated electric power generation.

FIG. 2: Illustrates a schematic drawing of a single MOD batch apparatus for PRO in CC with 3 electric generators for rated electric power generation.

FIG. 3A: Illustrates a schematic drawing of a single MOD single SC apparatus for PRO in CC by a continuous consecutive sequential process for rated electric power generation; wherein, a disengaged decompressed SC undergoing replacement of HSDF with fresh HSF.

FIG. 3B: Illustrates a schematic drawing of a single MOD single SC apparatus for PRO in CC by a continuous consecutive sequential process for rated electric power generation; wherein, a disengaged compressed SC full with fresh HSF is on stand-by for engagement with the PRO-MOD.

FIG. 3C: Illustrates a schematic drawing of a single MOD single SC apparatus for PRO in CC by a continuous consecutive sequential process for rated electric power generation; wherein, an engaged SC supplies HSF to inlet MOD and receives HSDF from its outlet.

FIG. 3D: Illustrates a schematic drawing of a single MOD single SC apparatus for PRO in CC by a continuous consecutive sequential process for rated electric power generation; wherein, a disengaged and decompressed SC awaits replacement of HSDF with HSF.

FIG. 4: Illustrates a schematic drawing of an apparatus with three MOD connected in parallel and a single SC for PRO in CC by a continuous consecutive sequential process for rated electric power generation; wherein, a disengaged decompressed SC undergoing replacement of HSDF with HSF.

FIG. 5A: Illustrates a schematic drawing of an apparatus with a single MOD and two SC (1^{st} and 2^{nd}) for continuous rated electric power generation; wherein, MOD fed by internal recycling of HSDF, one disengaged SC (1^{st}) on stand-by for engagement and the other disengaged SC (2^{nd}) undergoing replacement of HSDF by HSF.

FIG. 5B: Illustrates a schematic drawing of an apparatus with a single MOD and two SC (1^{st} and 2^{nd}) for continuous rated electric power generation; wherein, an engaged SC (1^{st}) supplies HSF to inlet of MOD and receives HSDF form its outlet and a disengaged SC (2^{nd}) with pressurized HSF on stand-by for engagement.

FIG. 5C: Illustrates a schematic drawing of an apparatus with a single MOD and two SC (1^{st} and 2^{nd}) for continuous rated electric power generation; wherein, the alternately engaged SC (2^{nd}) supplies HSF to inlet of MOD and receives HSDF from its outlet, and with alternately disengaged SC (1^{st}) undergoing replacement of HSDF with HSF.

FIG. 6A: Illustrates a schematic drawing of an apparatus with three MOD connected in parallel and two SC (1^{st} and 2^{nd}) for continuous rated electric power generation; wherein, MOD fed by internal recycling of HSDF, one disengaged SC (1^{st}) on stand-by for engagement and the other disengaged SC (2^{nd}) undergoing replacement of HSDF with HSF.

FIG. 6B: Illustrates a schematic drawing of an apparatus with three MOD connected in parallel and two SC (1^{st} and 2^{nd}) for continuous rated electric power generation; wherein, an engaged SC (1^{st}) supplies HSF to inlets of MOD and receives HSDF form their outlets and a disengaged SC (2^{nd}) with pressurized HSF on stand-by for engagement.

FIG. 6C: Illustrates a schematic drawing of an apparatus with three MOD connected in parallel and two SC (1^{st} and 2^{nd}) for continuous rated electric power generation; wherein, the alternately engaged SC (2^{nd}) supplies HSF to inlets of MOD and receives HSDF from their outlets, and with alternately disengaged SC (1^{st}) undergoing replacement of HSDF with HSF.

### DETAILED DESCRIPTION OF THE INVENTION

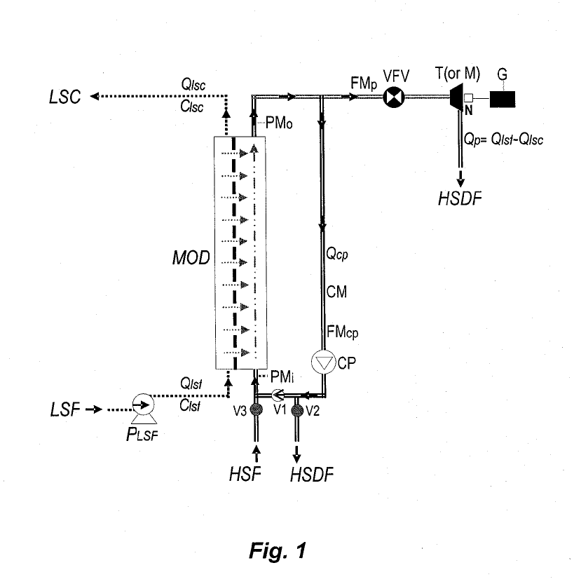

The conceptual progression of the invention begins with a batch apparatus for PRO in CC of the schematic design in FIG. 1 with a module (MOD) comprising two sections separated (dashed line) by semi-permeable membranes, one for a low salinity stream (dotted line) at low pressure (<1.0 bar) and the other for recycled high salinity solution in CC (doubled line) at high pressure. The inlets and outlets associated with the different sections of said MOD are well distinguished from each other by the shape of lines with direction of flow indicated by arrows. The inlet flow rate of LSF (Q_{lsf}), which becomes Low Salinity Concentrate (hereinafter “LSC”) at outlet (Q_{lsc}), is controlled by means of a low pressure pump (P_{LSF}) and the recycling flow rate of HSDF (Q_{cp}) controlled by means of a circulation pump (CP). The CC comprises a line for HSDF recycling from outlet to inlet of MOD and a line extension to a T (or M instead) with flow meter (FMₚ) and VFV means to enable the constant speed (N) actuation of said T (or M instead), and therefore, the production of rated electric power by the attached generator(G). The constant speed actuation of said T (or M instead) proceeds by a fixed flow supply of pressurized HSDF to said T (or M instead) through said VFV means in response to control by said FMₚ, or alternatively, in response to control by the said rpm meter N. The other components in the apparatus of the preferred embodiment displayed in FIG. 1 include the flow meter FM_{cp} and the conductivity meter CM in the CC line for HSDF recycling, the pressure meters at inlet (PMᵢ) and outlet (PMₒ) of said MOD, and the two-way actuated valve means V1, V2 and V3 whereby replacement of HSDF by fresh HSF takes place after batch sequence completed.

Prior to actuation of the preferred embodiment apparatus with the design displayed in FIG. 1, both sections of LSF-LSC and HSF-HSDF are charged with fresh solutions through the appropriate valve means, then, a PRO sequence initiated with actuated valves positioned as followed; V1[O], V2[C] , V3[C] and VFV[O]; wherein “O” stands for an open position and “C” for a closed position. The pressure rise in said MOD manifests the osmotic pressure difference between the two feed solutions (An). For instance, a maximum osmotic pressure difference (Δπ) of about 26 bar is to be expected in said MOD of the inventive apparatus in FIG. 1 by the application HSF of 35,000 ppm and LSF of 500 ppm. The batch PRO sequence in said inventive apparatus proceeds under the fixed flow conditions selected for P_{LSF}(Q_{lsf}), CP(Q_{cp}) and for the VFV controlled system whereby permeation flow is determined (Qₚ). Constant permeation flow controlled by the VFV system determines the average FO flux in said MOD as well as the flow rate difference between inlet LSF (Q_{lsf}) and outlet LSC (Q_{lsc}) in the low salinity section of the MOD. Control of the flow rates in the low salinity section of the MOD also determines the concentration of the LSC stream (C_{lsc}), derived from the LSF flow (Q_{lsf}) and its concentration (C_{lsf}).

Pressure variations during the PRO sequence in said MOD of the preferred embodiment apparatus displayed in FIG. 1 cover the range between a maximum pressure (pₘₐₓ), determined by the initial osmotic pressure difference (Δπₘₐₓ) created by HSF and LSF, and a minimum pressure (pₘᵢₙ) dictated by the concentration of the LSC and HSDC at the desired sequence termination point which manifests a minimum osmotic pressure difference (Δπₘᵢₙ). The duration of the PRO sequence is determined by the intrinsic volume (V) of said MOD, the controlled permeation rate (Qₚ) and the selected minimum sequential pressure (pₘᵢₙ). Since the term V is unchanged, therefore, increased permeation flow (Qₚ) at a fixed termination pressure (pₘᵢₙ) will result with a decreased PRO sequence period and vice versa. The complete MOD volume (V) recycling period in the apparatus of the preferred embodiment displayed in FIG. 1 depends on Q_{cp} and expressed by V/Q_{cp} and the number of full volume (V) cycles per PRO sequence determined by the selected minimum sequential pressure (pₘᵢₙ).

Power variations during the PRO sequence in said MOD of the preferred embodiment apparatus displayed in FIG. 1 are determined by the fixed permeation flow (Qₚ), the same as pressurized flow of HSDF which actuates the T-G (or M-G instead) power generation system, and the PRO sequential pressures range pₘₐₓ→pₘᵢₙ. Rated electric power generation in said inventive design is confined to a single power band (P_{G}) defined by (1) or (2); wherein, ƒ_{g} stands for the efficiency factor of the entire T-G electric power generation system. In simple terms, only pₘᵢₙ/pₘₐₓ of the maximum available sequential power is utilized for rated electric power generation.

P_{G}=[Qₚ*pₘᵢₙ/36]*ƒ_{g} (1)

P_{G}=[(Q_{lsf}−Q_{lsc})*pₘᵢₙ/36]*ƒ_{g} (2)

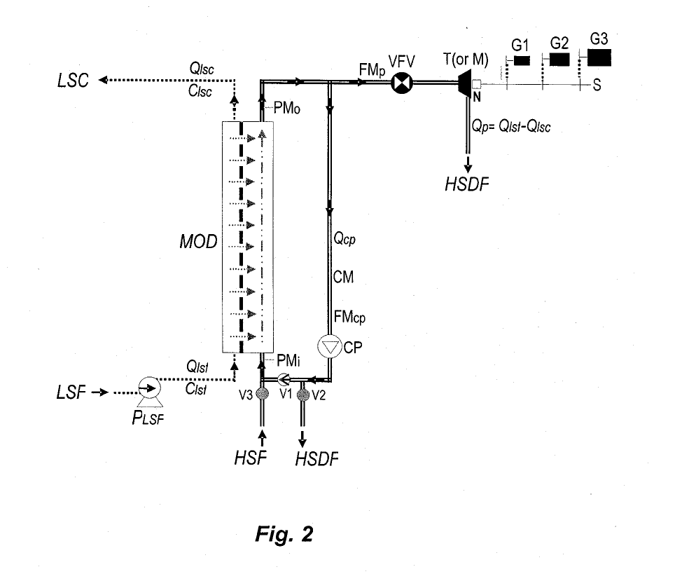

The apparatus of the preferred embodiment for improved PRO sequential power generation displayed in FIG. 2 differs from that in FIG. 1 only with respect to the rated electric power generation assembly. The fixed speed (constant N) of variable torque experienced at the shaft (S) of said T (or M instead) during the PRO sequence in the inventive apparatus in FIG. 2, is translated rated electric power by means of three rated generators (G1, G2 and G3) which are actuated alternately and/or simultaneously, by a gear-clutch mechanism means, as function of the monitored (PMₒ and/or PMᵢ) sequential pressure which manifests the power availability of the system. The adding of several rated power generation bands along the PRO sequence in closed circuit provides the means for an improved electric power output. For instance, the three generators in inventive apparatus displayed in FIG. 2 enable a declined power generation (e.g., G1+G2+G3>G1+G2>G1) along the PRO sequential range defined by pₘₐₓ→pₘᵢₙ; whereas, the use of a single generator confined the power output to G1.

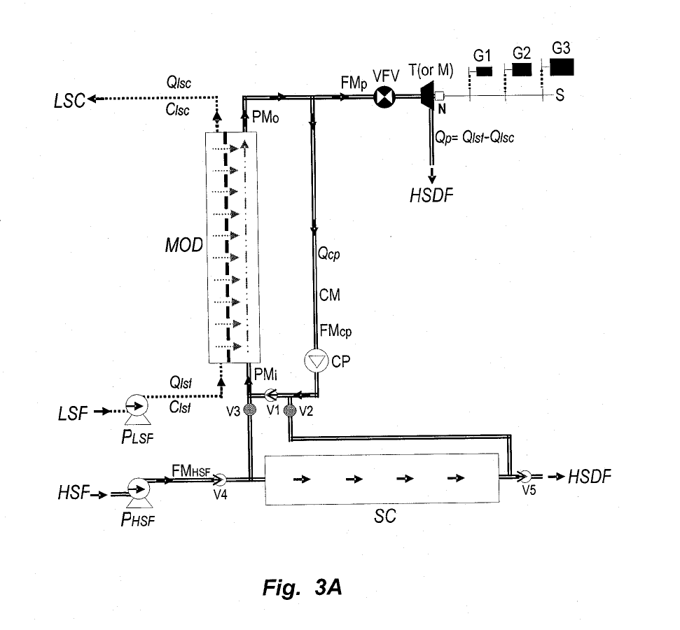

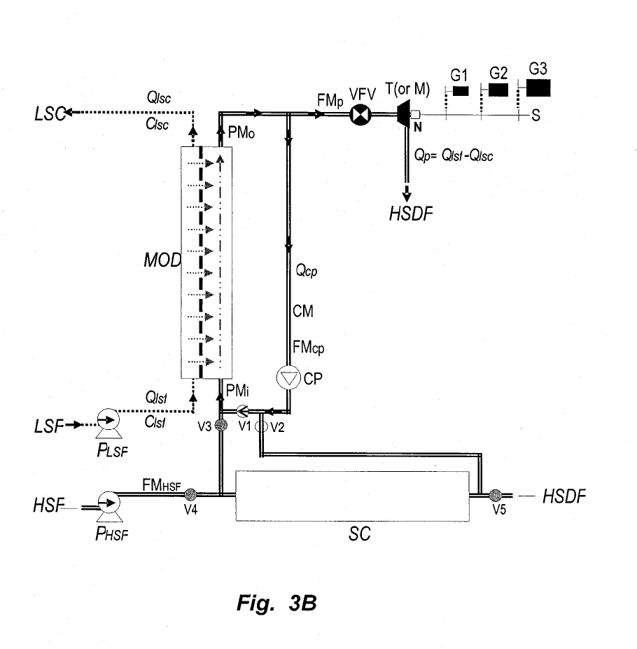

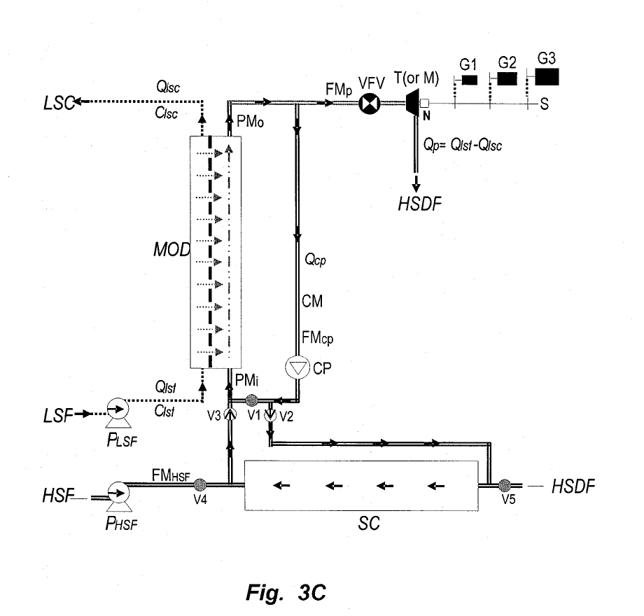

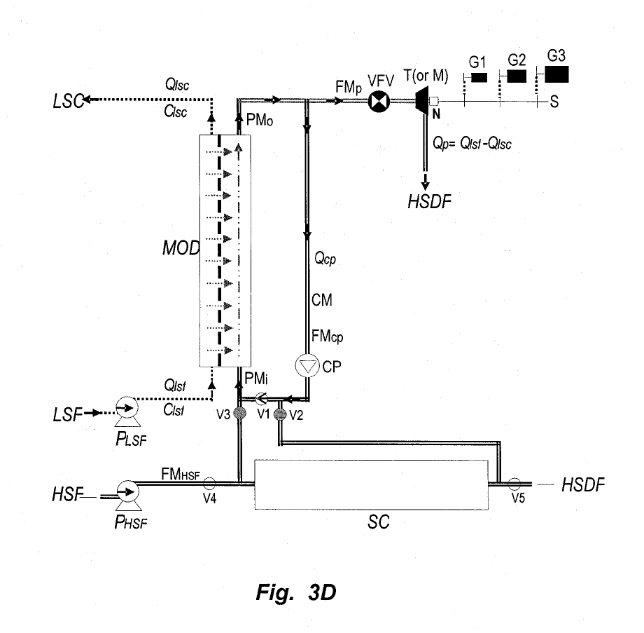

In order to enable the continuous operation of CC PRO power generation apparatus it is necessary to remove HSDF and supply HSF without stopping the process and this can be achieved by means of one or more than Side Conduit (hereinafter “SC”) with line and valve means to enable engagement/disengagement with the MOD attached to the CC of the PRO system. The preferred embodiment of the inventive apparatus for continuous power generation by PRO in CC according of the schematic design in FIG. 3 (A-D) comprises the basic inventive unit displayed in FIG. 2 with added features such as a SC; a line from outlet of V2 to inlet of said SC for receiving HSDF; a line from outlet of said SC to inlet of V3 for supply of HSF to MOD; a supply pump (P_{HSF}) of HSF to said SC; a delivery line with a flow meter (FM_{HSF}) and valve means (V4) for conducting a defined volume of HSF from said pump to said SC; and an outlet line with valve means (V5) from the said SC to drain for disposing HSDF. The principle actuation modes of the invented apparatus during a continuous PRO power generation in CC proceed as followed: FIG. 3A illustrates the configuration of the inventive apparatus wherein the disengaged decompressed SC undergoing fast replacement of HSDF with HSF using the low pressure pump P_{LSF}; FIG. 3B illustrates the configuration of the inventive apparatus wherein the disengaged compressed SC awaits on stand-by for engagement with the MOD; FIG. 3C illustrates the configuration of the inventive apparatus wherein engagement of the SC and MOD enables replacement of HSDC with HSF in said MOD without stopping power generation; and FIG. 3D illustrates the configuration of the inventive apparatus wherein the disengaged decompressed SC awaits the actuation of the low pressure pump PLSF for replacement of HSDC with HSF.

The method of operation of the inventive apparatus for continuous PRO in closed circuit according preferred embodiment displayed in FIG. 3 proceeds by the following steps: [A] The disengaged SC is being recharged with HSF according to FIG. 3A while PRO power generation in CC takes place with internal HSDF recycling. [B] After the recharge of the SC with a fixed monitored (FM_{HSF}) volume of HSF completed, the SC is sealed, pressurized and left on stand-by for the next engagement according to FIG. 3B. [C] The engagement of the SC with the CC is initiated by a monitored pressure signal (PMₒ), and/or by a monitored conductivity signal (CM), which manifest the selected minimum pressure range of the PRO sequence; and thereafter, the operation of the engaged system proceeds according to FIG. 3C. [D] The disengagement of the SC from the CC is prompted after the replaced monitored volume (FM_{cp}) of HSDC with HSF match the intrinsic volume of the MOD, then the disengaged SC is decompressed according to FIG. 3D, and thereafter, a new cycle (steps: A→D in FIG. 3) is resumed.

Continuous electric power generation by the inventive apparatus of the preferred embodiment displayed in FIG. 3 proceeds with two power level ranges according to the configuration (engaged or disengaged) of the SC with respect to the CC. The high power output range attained by said system during its engaged configuration due to HSF supply to inlet of MOD; whereas, the low power output range occurs during the disengaged configuration and manifests the lower salinity supply at inlet to MOD of recycled HSDF. The actual power generation profile, a combination of the two power level ranges, depends on the selected permeation flow (Qₚ), recycling flow (Q_{cp}), the volume of the SC as well as on the rated power of the specific generators and their actuation modes according to the CC pressure.

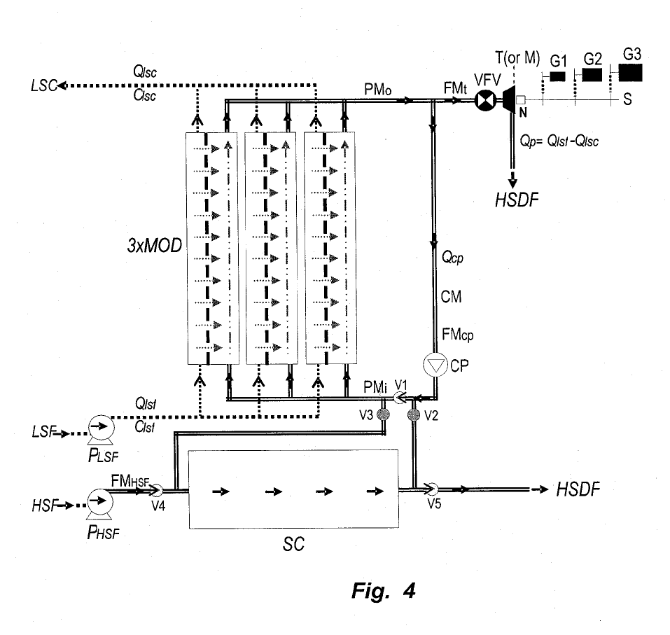

The design and operational principles of the single MOD inventive apparatus the schematic design in FIG. 3 can be expanded to include more than one MOD with their inlets and outlets connected in parallel to the closed circuit and their combined intrinsic volume match that of the SC, or smaller. The inventive apparatus of the preferred embodiment with three MOD and a single SC of the design displayed in FIG. 4 illustrates a three-fold expansion of the basic inventive apparatus in FIG. 3 and the same approach may apply to the design of analogous inventive apparatus with any desired number of MOD.

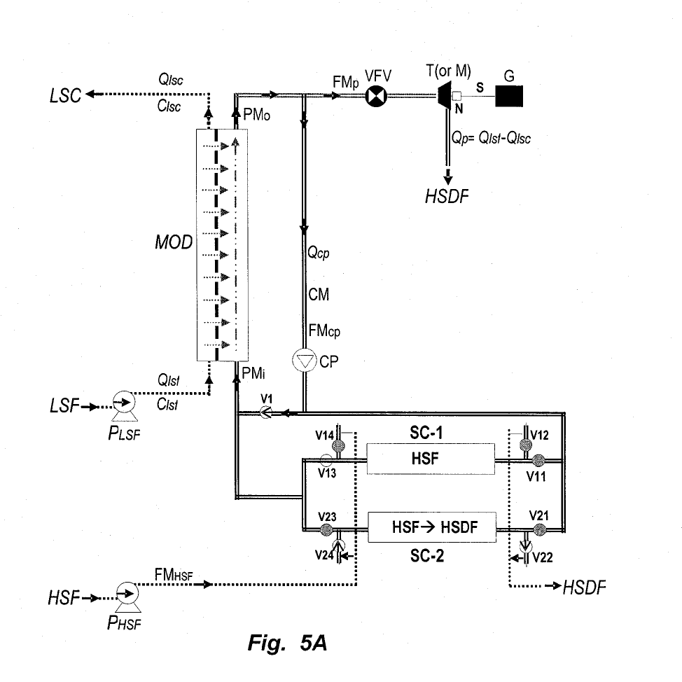

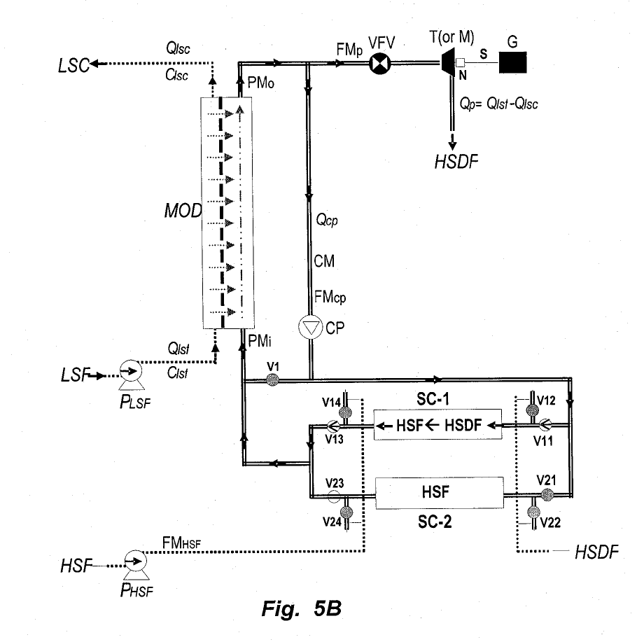

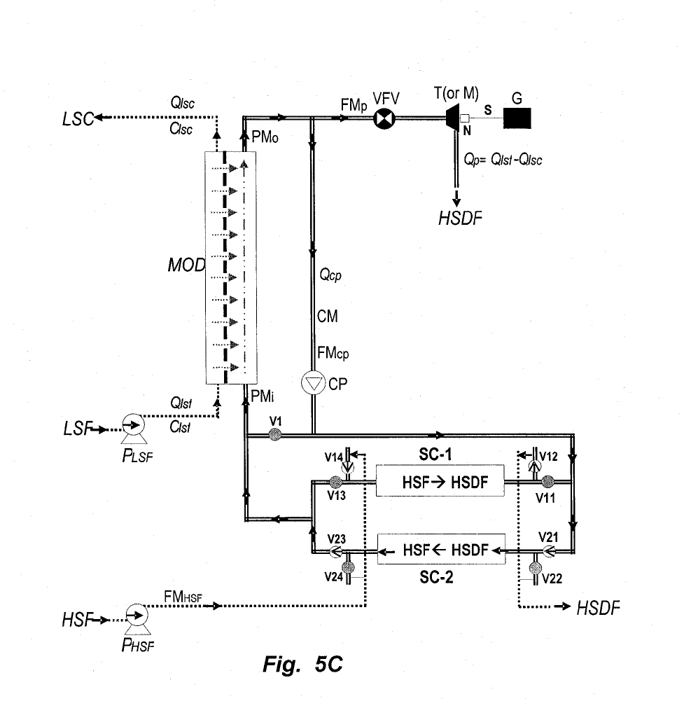

The ideal CC PRO power generation system (osmotic-electric) requires the continuous supply of HSF at inlet to MOD without need for pressurizing the feed by ER means. The stated requirement of an ideal CC PRO power generation system is fulfilled by the alternating application of two SC according to the preferred embodiment of the invented apparatus in FIG. 5(A-C); wherein, A→C describe the principle actuation modes of the two SC in the inventive apparatus. The inventive apparatus of preferred embodiment displayed in FIG. 5 combines the single MOD inventive design displayed in FIG. 1 with two SC means of alternating actuating modes for continuous supply of HSF to inlet of MOD. The parallel arrangement of the two SC means (labeled SC-1 and SC-2) in FIG. 5 with separate connection lines and valves means to the CC of the MOD, enable their alternating engagement with the CC of the MOD for continuous supply of HSF. The alternating engagement of the two SC with the CC of the MOD enables continuous supply of HSF to inlet of MOD with simultaneous removal of HSDF from its outlet without need of ER means. While one SC is engaged with the MOD, the disengaged SC undergoes replacement of HSDF with HSF, then sealed, compressed and left on stand-by for the next engagement. The switching between alternating side conduits (SC-1 and SC-2) during the operation of the inventive apparatus of the design in FIG. 5, proceeds by means of a volumetric signal from FM_{cp} of the selected transferred volume. The disengaged SC undergoes, decompression, replacement of fixed volume of HSDF with HSF through P_{HSF} and FM_{HSF}, and then, the recharged SC is sealed, compressed and left on stand by for the next engagement. Compressed/decompression of SC according to the inventions (FIG. 5) proceeds through valve means manipulations with compression achieved by connecting a sealed SC with HSF to the pressurized CC line and decompression by connecting a disengaged SC with HSDF to the atmosphere.

The principle actuation modes of the inventive apparatus of the preferred embodiment in FIG. 5(A-C) are as followed: FIG. 5A shows a CC MOD system operated with internal recycling and disengaged SC means; wherein, SC-1 with pressurized HSF in a stand-by position for engagement, SC-2 undergoing HSDF replacement with HSF (HSF→HSDF), valve means positioned as indicated in brackets V1[O], V13[O] , V22[O], V24[O], V11[C], V12[C], V14[C], V21[C] and V23[C] and with the pumps CP, P_{LSF} and P_{HSF} actuated simultaneously. FIG. 5B shows a CC MOD system operated with external recycling through SC-1; wherein, SC-1 supplies pressurized HSF to inlet of MOD and receives HSDF from its outlet, SC-2 with pressurized HSF in a stand-by position for engagement, valve means positioned as indicated in brackets V1[C], V13[O] , V22[C], V24[C], V11[0], V12[C], V14[C], V21[C] and V23[0] and with the pumps CP and P_{LSF} actuated simultaneously while P_{HSF} kept temporarily idle. FIG. 5C shows a CC MOD system operated with external recycling through SC-2; wherein, SC-2 supplies pressurized HSF to inlet of MOD and receives HSDF from its outlet, SC-1 undergoing HSDF replacement with HSF (HSF→HSDF), valve means positioned as indicated in brackets V1[C], V13[C] , V22[C], V24[C], V11[C], V12[O], V14[O], V21[O] and V23[O] and with the pumps CP, P_{LSF} and P_{HSF} actuated simultaneously.

The volume of the SC means in the inventive apparatus of preferred embodiment apparatus displayed in FIG. 5 should be large enough to enable a sufficient time period for the recharge of the disengaged SC and account for a safe brief stand-by time interval before next engagement with the CC MOD system. The continuous supply of HSF to the inlet of the CC MOD under conditions of fixed permeation flow (Qₚ=constant) implies that the concentration of HSDF at the outlet of said MOD will depend on the recycling flow by CP, with increased recycling flow concomitant with higher HSDF concentration at outlet of MOD and vice versa. Operating said inventive apparatus with constant permeation flow (Qₚ), dictated by the VFV control means, and fixed recycling flow by CP will generate, after a brief initiation period, a fixed steady state concentration gradient of HSF-HSDF inside said MOD vessel, thereby, creating a steady NDP of FO which under ideal conditions manifests the net osmotic pressure difference (Δπ) between the mean values of the LSF-LSC and the HSF-HSDF feed systems. In practice, the none ideal transport properties/characteristics across semi-permeable membrane surfaces will effect a much lower NDP of FO in the CC MOD of said inventive apparatus compared with the theoretically expected value (Δπ). If p_{NDP} (bar) stands for the actual NDP of FO in the CC MOD of the said inventive apparatus (p_{NDP}<Δπ) and S for the ratio of actual to ideal net driving pressures, then, PNDP is expressed by (3) and PRO power generation (kWh) with fixed permeation flow (Qₚ−m³/h) expressed by (4); wherein, μ stands for the efficiency factor of the T-G electric generation system in the design displayed in FIG. 5. The PD (Power Density) (Watt/m²) of said inventive design displayed in FIG. 5 is expressed by (5); wherein, S (m²) stands for the membrane surface area in the CC PRO MOD. The unchanged average gradient concentration and FO pressure in the CC MOD vessel of said inventive apparatus in FIG. 5 imply a single electric power generation mode; therefore, the need for a single electric generator as is displayed in the design and in this case the function of the VFV-FMₚ system is to enable the fine tuning of the rotational speed of the T(or M instead).

p_{NDP}(bar)=δ*Δπ (3)

P_{PRO-5}(kWh)=μ*δ*Δπ*Qₚ/36 (4)

PD_{PRO-5}(watt/m²)=μ*δ*Δπ*Qₚ*1000/36 (5)

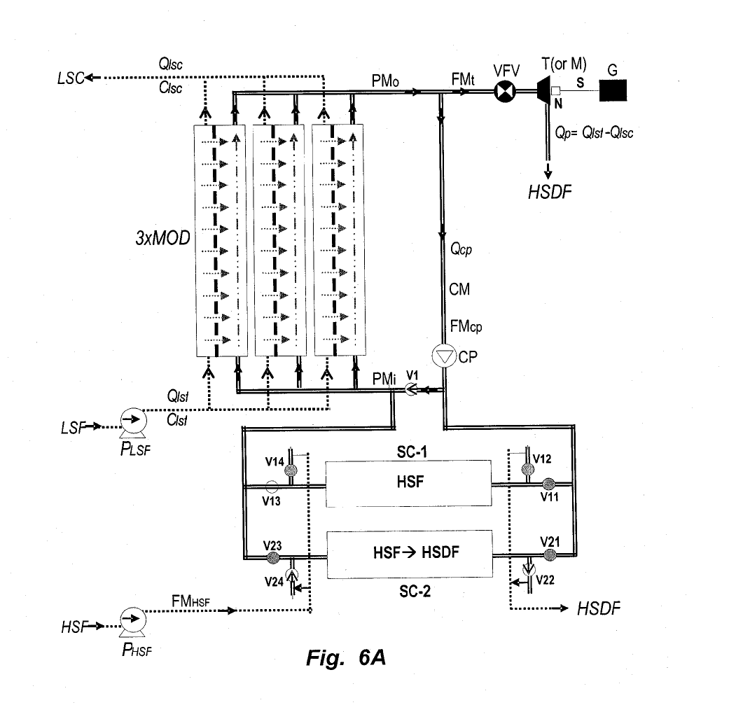

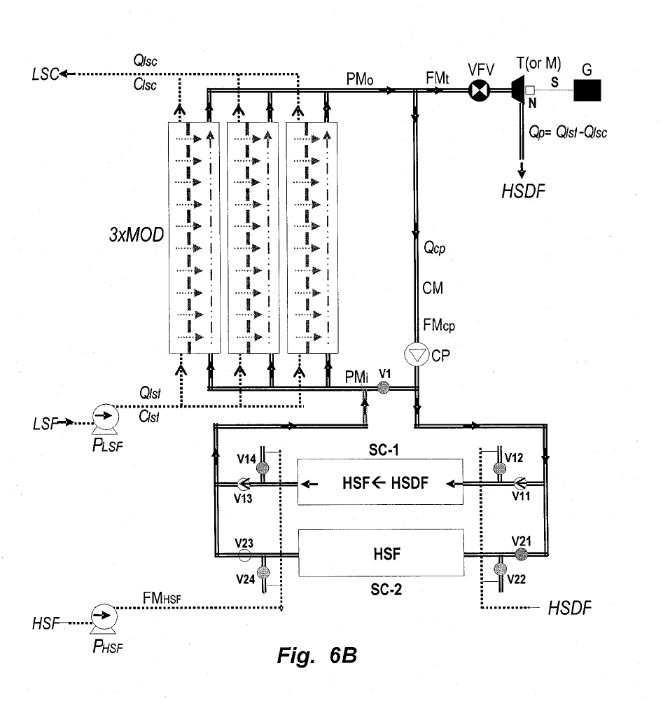

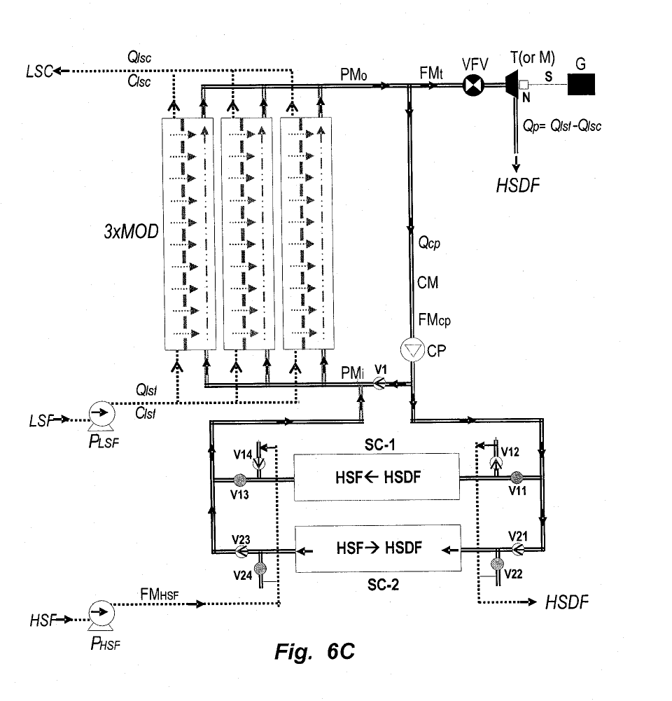

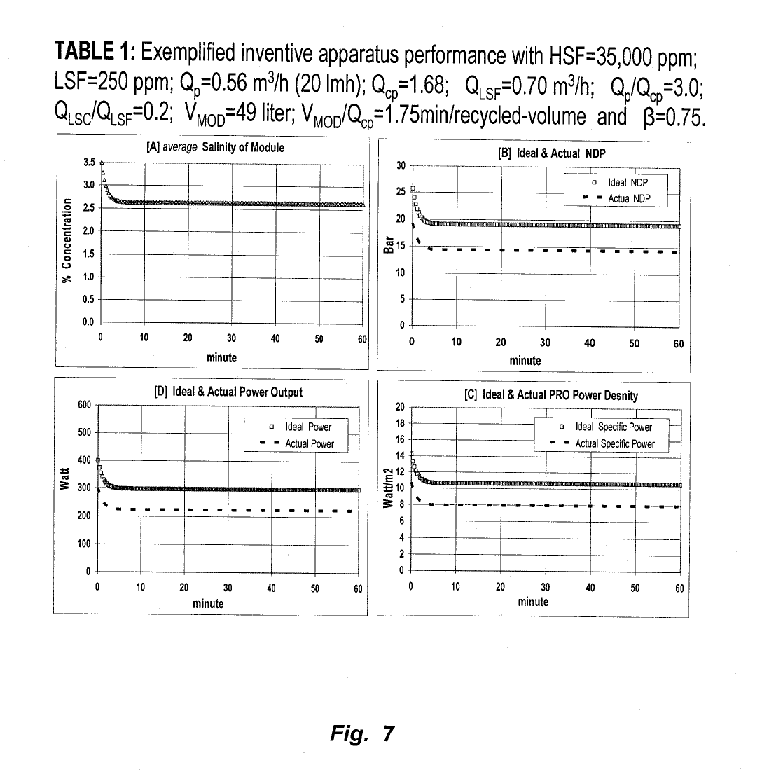

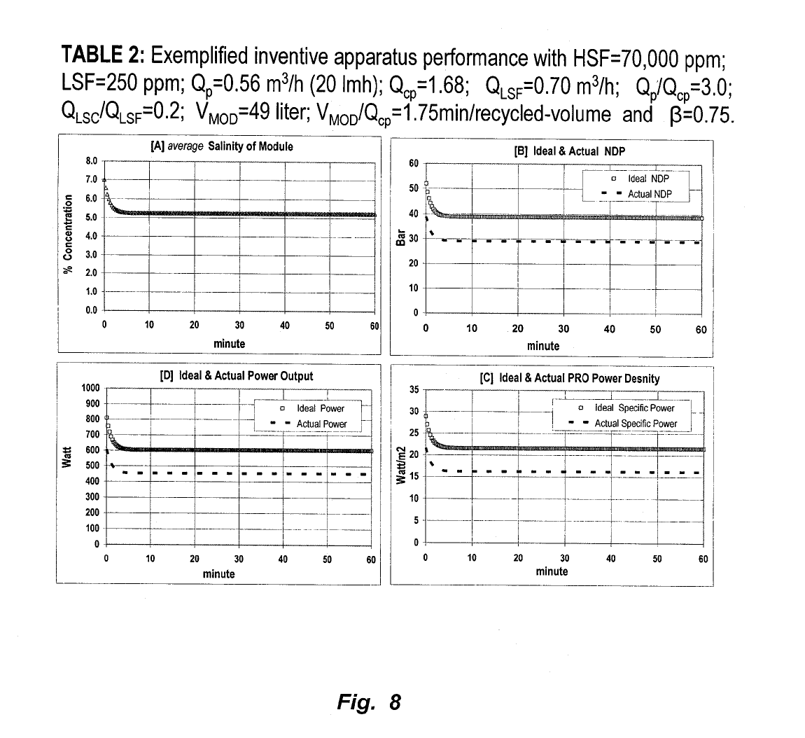

The inventive apparatus of the preferred embodiment with a single CC MOD and two alternating side conduits of the design displayed in FIG. 5 is just one example of a general class of apparatus comprising many PRO modules with their inlets and outlets connected in parallel to the CC with two SC of suitable volume capacity to enable a continuous supply of HSF into the inlets of said MOD. The inventive apparatus of the preferred embodiment with three MOD and two SC of the schematic design in FIG. 6 (A-C), with its principle actuation modes of complete analogy to those already considered in the context of the single MOD design in FIG. 5(A-C), provides an illustration of the appropriate design approach to an extensive class of φ*MOD+2*SC type of inventive apparatus with φ≧1.

The method of operation of the inventive class of apparatus of the type φ*MOD+2*SC (φ≧1) proceeds as followed: The entire inventive apparatus (modules and side conduits) is charged with HSF using the P_{HSF} pump and the appropriate line and valve means and this before the start of LSF supply pump P_{LSP}. After recharge completed, the initial configuration of said apparatus should comprise one SC engaged with the CC MOD with a disengaged second SC in a stand-by positions for next engagement. Next, the P_{LSP} and CP pumps are activated and the PRO power generation process begins. After a brief induction period the system will attain its fixed operational power level and power production will remain steady thereafter irrespective of the alternating actuation modes of the SC. Alternation between SC takes place by a control signal from the CC flow monitor (FM_{cp}) when the selected volume of HSF is admitted to the CC MOD and this volume is equivalent to that of removed HSDF.

It will be understood that the design of the preferred embodiments of the inventive apparatus for the PRO electric power generation in CC shown in FIG. 1, FIG. 2. FIG. 3 (A-D), FIG. 4, FIG. 5(A-C) and FIG. 6(A-C) are schematic and simplified and are not to be regarded as limiting the invention. In practice, the units and apparatus according to the invention may comprise many additional lines, branches, valves, and other installations, components and devices as rendered necessary according to specific requirements, while still remaining within the scope of the inventions and claims.

The preferred embodiments of the basic inventive apparatus for PRO electric power generation in CC are exemplified in FIG. 1-2 with a single MOD and without SC, in FIG. 3 with a single MOD and a single SC, in FIG. 4 with three MOD and a single SC, in FIG. 5 with a single MOD and two SC and in FIG. 6 with three MOD and two SC and this for the purpose of simplicity, clarity, uniformity and the convenience of presentation. It will be understood that the general design according to the invention is neither limited nor confined to apparatus with one or with three MOD. Specifically, it will be understood that apparatus according to the inventive method may be comprised of any desired number of MOD with their respective inlets and outlets connected in parallel to the CC. It will also be understood that the general design according to the invention is neither limited nor confined to apparatus with one SC or with two SC. Specifically, it will be understood that apparatus according to the inventive method may be comprised of many SC which could be engaged or disengaged alternately and/or simultaneously with MOD in the CC for HSF supply and removal of HSDF thereby enable continuous PRO electric power generation in the inventive apparatus.

The scope of the invention is neither confined nor limited to the design and construction of modest size apparatus and clusters of such apparatus for the harvesting of clean energy by means PRO electric power generation in CC, and that the inventive apparatus and method could apply to the design of large scale industrial systems created by the parallel joining of many of the inventive apparatus in compliance with the concepts and principles of the invention.

Concentrate recycling in the closed circuit of the inventive apparatus and method is done by circulation means. It will be understood that the circulation means according to the invention may be comprised of a suitable single circulation pump, or instead, of several circulation pumps, applied simultaneously in parallel and/or in line.

Conversion of pressurized flow to rated electric power according to inventive method is done by a fixed speed controlled T (or M instead), which actuates one rated generator according to the inventive apparatus with the preferred embodiment shown in FIG. 1-2, FIG. 5(A-C) and FIG. 6(A-C), or of three rated generators according to inventive apparatus with the preferred embodiment shown in FIG. 3(A-D) and FIG. 4. It will be understood that the general design according to the invention is neither limited nor confined to the actuation of one or three rated generators through the fixed speed variable torque shaft of the T (or M instead). Specifically, it will be understood that any desired number of rated generators could be actuated either simultaneously or separately through the fixed speed variable torque shaft of the T (or M instead).

It will be obvious to those versed in the art that the inventive apparatus and method on the basis of PRO in CC described hereinabove may apply to a batch process or to a continuous consecutive sequential process, with discrete apparatus or with small or large clusters of such apparatus of different designs, as already explained hereinabove with respect to the inventive apparatus and/or clusters made of such apparatus, as long as such apparatus comprise one MOD or many such MOD with their respective inlets and outlets connected in parallel to the CC and/or clusters made of many such apparatus with a CC and circulation means to enable recycling of concentrates; inlet lines with valves means as appropriate for admitting low salinity feed and high salinity feed; outlet lines with valve means for dispensing effluents originating from LSF and HSF; a line from the CC to a fixed flow and fixed speed T (or M instead) which actuates one or several rated electric generators alternately and/or simultaneously and one or more than one SC which are alternately and/or periodically engaged with the MOD in the CC for continuous and/or periodic supply of fresh HSF and removal of HSDF effluents.

While the invention has been described hereinabove in respect to particular embodiments, it will be obvious to those versed in the art that changes and modifications may be made without departing form this invention in its broader aspects, therefore, the appended claims are to encompass within their scope all such changes and modifications as fall within the true spirit of the invention.

It will be also obvious to those versed in the art pertinent to the inventive apparatus and method that the HSF and the LSF solutions referred to hereinabove in the context the inventive apparatus, may comprise any aqueous solutions of sufficient osmotic pressure difference between them to enable performing an effective PRO electric power generation in CC.

### EXAMPLE

The application of the inventive apparatus of the preferred embodiment in FIG. 5 comprising a single MOD (V=49 liter free volume and 28 m² membrane surfaces) and 2 side conduits (50 liter each) of alternating actuation mode for continuous power generation by PRO in CC is exemplified using HSF of 35,000 ppm (or 70,000 ppm instead) and LSF of 250 ppm with fixed permeation flow (Qₚ) across the semi-permeable membrane and recycling flow 3-fold greater (Q_{cp}=3*Qₚ) under the created osmotic pressure difference between HDSF and LSC (Δπ) in the absence any applied pressure due to ER means. The two alternately engaged side conduits with the CC continuously supply fresh HSF to the inlet of the MOD and remove HSDF effluent from its outlet and the period of a complete recycled volume inside said apparatus expressed by V/Q_{cp}. The low salinity feed flow in the system (LSF→LSC), wherefrom Qₚ derived, is operated with a flow ratio expressed by Q_{LSC}/Q_{LSF}=0.2.

In the absence an applied hydraulic pressure (Δp), the effective Net Driving Pressure (NDP_{effect}) in the exemplified PRO process is a function of Air and expressed by NDP_{effect}=β*Δπ; wherein, β stand for an empirical coefficient which takes into account of the various detrimental effects (e.g., concentration polarization, transport limitations across the porous support of the active semi-permeable layer, etc.) which adversely influence such a process. Membranes with favorable porous support of the active layer considered the context of the exemplified inventive apparatus with extensive cross flow of HSDF created by CP and without any applied pressure (Δp) component, should enable high NDP_{effect}—probably twice that experienced with a conventional PRO power generation techniques whereby Energy Recovery means supply pressurized feed of 10-12 bar at inlet to MOD in a system comprising HSF of 35,000 ppm and LSF of 250 ppm. Accordingly, the selection of β=−0.75 to estimate NDP_{effect} from An in the exemplified operational features of the inventive apparatus for continuous CC PRO power generation in based on reasonable assumptions.

The principle operational parameters, both ideal and projected, of module salinity [A], module pressure [B], PRO power density [C] and PRO power output [D] of the exemplified inventive apparatus of the schematic design in FIG. 5 are illustrated with a fixed permeation flux of 20 lmh for HSF of 35,000 ppm in FIG. 7 (Table 1) and for HSF of 70,000 ppm in FIG. 8 (Table 2).

1. An apparatus for power generation by pressure retarded osmosis in closed circuit (PRO-CC) without need of energy recovery means comprising:
at least one module comprising a pressure vessel with a semi-permeable membrane section inside, an inlet line to the interior of said membrane section for supply of Low Salinity Feed (LSF) and an outlet line for removing Low Salinity Concentrate (LSC), an inlet line to said vessel for supply of a High Salinity Feed (HSF) on external surfaces of said membrane and an outlet line for removing High Salinity Diluted Feed (HSDF), a line connecting between inlet to outlet of said vessel to enable closed circuit recycling of said HSDF through said module or many such modules with their respective inlets and outlets connected in parallel;
a line extending from said closed circuit for conducting pressurized flow of HSDF produced by said PRO-CC to a system comprising a fixed flow constant speed turbine means, or fixed flow constant speed hydraulic motor means instead, coupled with a rated electric power generation means, whereby hydraulic power is converted to rated electric power in said apparatus;
at least one circulation system in said closed circuit to enable cross flow of HSDF over said external surfaces of membrane(s) in said module(s);
at least one low pressure LSF pump means for supply of LSF to said apparatus;
at least one low pressure HSF pump means for supply of HSF to said apparatus;
a Side Conduit (SC) means of same or larger intrinsic volume than that of said module(s) comprising; a line from outlet of said SC to inlet(s) of said module(s) for HSF supply, a line from outlet(s) of said module(s) to inlet of said SC for removing HSDF, an inlet line to said SC from said low pressure HSF pump means for HSF recharge and an outlet line from said SC for disposing HSDF;
a valve means in said lines to enable periodic engagement between said SC means charged with HSF and said module(s) for replacement of consumed HSDF by HSF while PRO-CC is continued, and thereafter the disengagement of said SC means from said module(s) after said replacement completed to enable recharge of said disengaged SC means with said HSF in readiness for next engagement;
a monitoring means of said PRO-CCD process parameters in said apparatus to enable the follow up of its performance; and
a control system coupled with said monitoring means, valve means and pump means for the managing of the selected actuation mode of said apparatus.

2. The apparatus according to claim 1 wherein monitoring means for control and follow up of performance comprise monitoring devises for pressure, flow and electric conductivity.

3. The apparatus according to claim 1 wherein said circulation system for recycling of HSDF comprises one or more than one circulation pump in line or in parallel.

4. The apparatus according to claim 1 wherein said a fixed flow constant speed turbine means, or fixed flow constant speed hydraulic motor means instead, incorporate a variable flow valve means controlled by a flow meter device and/or by a rpm meter device of revolving shaft in said of turbine, or hydraulic motor instead, whereby selected speed of said shaft maintained constant.

5. The apparatus according to claim 1 wherein said a rated electric power generation means comprise one or more than one rated electric generator actuated alternately and/or simultaneously at constant speed by the shaft of said turbine, or hydraulic motor instead, through a gear-clutch mechanism means as function of power availability bay said PRO-CC process of said apparatus.

6. The apparatus according to claim 1 wherein said Side Conduit (SC) means apply to two complete SC means in parallel of alternating engagement modes for continuously supplying HSF to inlet(s) of module(s) and removing HSDF from outlet(s) of module(s) in said apparatus, and while one SC is engaged with said module(s) the other disengaged SC undergoing decompression, replacement of HSDC with HSF and compression in readiness for next engagement with frequency of SC alternation depending on their intrinsic volume with lower frequency encountered with a larger volume and vice versa.

7. A method for conducting continuous PRO-CC for rated electric power generation without need of energy recovery in an apparatus with a single SC means according to any of the preceding claims 1-5 hereinabove; whereby, fresh HSF supplied to inlet(s) of said module(s) and HSDF removed from outlet(s) during periodic engagements of said SC means with said module(s); and whereas, recycled HSDF admitted to inlet(s) of said module(s) while said SC means disengaged from said module(s) for recharge by replacement of HSDF with HSF before next engagement, with disengagement duration determined by the intrinsic volume of said SC means combined with the time duration required for recharge, with a larger volume SC combined with a shorter recharge duration enable longer engagement periods and vice versa.

8. A method for conducting continuous PRO-CC for rated electric power generation without need of energy recovery in an apparatus with two SC means according to any of the preceding claims 1-4 and 6 hereinabove; whereby, fresh HSF supplied continuously to inlet(s) and HSDF removed continuously from module(s) of said module(s) by the alternating engagement of the two said SC means, such that when one SC is engaged with said module(s) the other SC is disengaged from said module(s) for recharge by replacement of HSDF with HSF before next engagement, said SC alternation frequency determined by the intrinsic volume of said SC means and the time period required for recharge, with decreased alternation frequency associated SC of larger intrinsic volume combined with a shorter recharge duration and vice versa.

9. The apparatus and methods according to any of the preceding claims 1-8 hereinabove; wherein, said high salinity feed and low salinity feed solutions to said apparatus by said methods apply to any aqueous solutions of a sufficient osmotic pressure difference between them to enable performing an effective pressure retarded osmosis process in closed circuit.
